(19) United States
(12) Patent Application Publication
(10) Pub. No.: US 2022/0086541 A1
(43) Pub. Date: Mar. 17, 2022

(54) DISTANCE-ROUTE RESOURCE SHARING FOR DISTRIBUTED FIBER OPTIC SENSORS

(71) Applicant: NEC Laboratories America, Inc., Princeton, NJ (US)

(72) Inventor: Philip JI, Cranbury, NJ (US)

(73) Assignee: NEC LABORATORIES AMERICA, INC, Princeton, NJ (US)

(21) Appl. No.: 17/468,543

(22) Filed: Sep. 7, 2021

Related U.S. Application Data
(60) Provisional application No. 63/077,300, filed on Sep. 11, 2020.

(51) Int. Cl. H04Q 11/00; G02B 6/35; H04B 10/25; H04L 7/00

(52) U.S. Cl. CPC H04Q 11/0062; G02B 6/3548; G02B 6/3588; H04Q 2011/0081; H04L 7/0075; H04Q 2011/0073; H04B 10/25

(57) ABSTRACT

Aspects of the present disclosure describe distributed fiber optic sensing (DFOS) systems, methods, and structures that advantageously employ a flexible resource sharing that balances sending distance requirements and route requirements. Such flexibility is achieved by including an ultra-fast 1×N optical switch with a DFOS interrogator and N fiber optic sensor routes. Synchronous control provides for real-time configuration/reconfiguration of the DFOS system.

### CROSS REFERENCE

This disclosure claims the benefit of U.S. Provisional Patent Application Ser. No. 63/077,300 filed 11 Sep. 2020, the entire contents of which is incorporated by reference as if set forth at length herein.

### TECHNICAL FIELD

This disclosure relates generally to fiber optic telecommunications networks and distributed fiber optic sensing (DFOS) systems, methods, and structures. More specifically, it pertains to distance-route resource sharing for distributed fiber optic sensors and systems, methods and structures constructed therefrom.

### BACKGROUND

Recently, distributed fiber optic sensing (DFOS) systems, methods, and structures have found widespread use in a number of applications due—in part—to its numerous advantages over traditional sensor systems and methods. Given this applicability and importance to contemporary sensing applications, systems, methods, and structures that facilitate or otherwise enhance the applicability of DFOS would represent a welcome addition to the art.

### SUMMARY

An advance in the art is made according to aspects of the present disclosure directed to distributed fiber optic sensing (DFOS) systems, methods, and structures that advantageously employ a flexible resource sharing that balances sending distance requirements and route requirements.

In sharp contrast to the prior art, systems, methods, and structures according to aspects of the present disclosure permit the sharing of a DFOS sensor among multiple routes with different sensing distance requirements. Consequently, an effective pulse repetition rate for each sensor employed by a DFOS system according to the present disclosure is not affected and no additional transmitter hardware or receiver hardware is required. Combining with network management considerations, and in particular network resource assignment management, a resource utilization of a DFOS system according to the present disclosure is improved for an entire network.

To achieve such superior performance, DFOS systems, methods, and structures according to aspects of the present disclosure employ an optical switch (ultra-fast) having synchronous control circuitry together with a non-uniform pulse generation, switching and data collection scheme(s) through internal control. Corresponding data processing and network planning also contribute to a superior performance of DFOS systems according to the present disclosure as compared to those of the prior art.

### BRIEF DESCRIPTION OF THE DRAWING

A more complete understanding of the present disclosure may be realized by reference to the accompanying drawing in which:

FIG. 1 is a schematic diagram of illustrative backscattered distributed fiber optic sensing operations generally known in the art;

FIG. 2(A) and FIG. 2(B) are plots illustrating transmitted and received optical signals in DFOS in which: FIG. 2(A) shows an optical pulse sent by an interrogator; and FIG. 2(B) shows optical backscattered signals received by the interrogator in response to the sent pulses;

FIG. 3(A), FIG. 3(B), and FIG. 3(C) are plots illustrating optical signals in DFOS continuous operation in which: FIG. 3(A) shows an optical pulse sent by an interrogator; FIG. 3(B) shows optical backscattered signals received by the interrogator in response to the sent pulses; and FIG. 3(C) shows backscattering signal trend for different locations along the optical sensing fiber;

FIG. 4(A), FIG. 4(B), FIG. 4(C), FIG. 4(D), and FIG. 4(E) are plots illustrating round-robin operation among 3 sensing routes in which: FIG. 4(A) shows an optical pulse sequence sent by an interrogator; FIG. 4(B) shows optical switch output port(s) that individually correspond to individual pulses of FIG. 4(A); FIG. 4(C) optical backscattered signals from a Route 1 received by the interrogator in response to the sent pulses; FIG. 4(D) shows optical backscattered signals from a Route 2 received by the interrogator in response to the sent pulses; and FIG. 4(E) shows optical backscattered signals from a Route 3 received by the interrogator, according to aspects of the present disclosure;

FIG. 5 is a schematic diagram showing illustrative examples of different sensing configurations enabled by resource sharing DFOS system according to aspects of the present disclosure;

FIG. 6(A) and FIG. 6(B) are plots illustrating transmitted and received optical signals in a resource sharing DFOS according to the present disclosure in which: FIG. 6(A) shows an optical pulse sequence sent by an interrogator; and FIG. 6(B) shows corresponding ultra-fast optical switch output port and optical backscattered signals received by the interrogator in response to the sent pulses according to aspects of the present disclosure;

FIG. 7(A), FIG. 7(B), and FIG. 7(C) are schematic diagrams illustrating examples of hardware saving and new service provisioning by a resource sharing DFOS system according to aspects of the present disclosure;

FIG. 8(A), and FIG. 8(B) are schematic diagrams illustrating examples of protection by a resource sharing DFOS according to aspects of the present disclosure; and

FIG. 9 is a flow diagram showing a hardware modifications and operation procedures for shared-resource DFOS according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background—we again note that in recent years, distributed fiber optic sensing (DFOS) has found widespread acceptance in numerous applications and has been much more widely used in such applications due to its many advantages over traditional single point sensors. With that in mind, one main advantage of DFOS over traditional, single point sensors is that each sensor (optical sensing fiber) may have thousands or more sensing points located along the length of the sensing fiber, therefore can deliver sensing function over a long distance with fine spatial resolution, replacing thousands of traditional single point sensors.

Due to the principle of optical sensing and the characteristics of fiber optics, DFOS also provide additional advantages such as high sensitivity, immunity to electromagnetic interference, light weight, robustness against harsh environment, no line-of-sight requirement, low latency, and self-synchronization among sensing points—among others.

As is known, DFOS systems can detect temperature, vibration, acoustic signal, strain, and other physical phenomena along a sensing fiber optic cable. As a result, it has found great utility in a great number of applications including—but not limited to—perimeter intrusion detection, oil and gas pipeline leakage detection, traffic monitoring, tunnel fire detection, and civil infrastructure health monitoring, etc.

Despite such utility and application however, there is nevertheless at least one drawback with such a contemporary DFOS sensor, namely an inflexible use of resource.

More particularly, one important component of a DFOS system—namely DFOS sensor hardware (usually called an interrogator)—typically has but optical sensing fiber port to connect to a sensing optical fiber cable. In addition, an allowed maximum length of the optical fiber sensing cable (the maximum sensing distance) is determined by the pulse repetition rate (the frequency of an optical pulse is transmitted down the optical fiber sensing cable) and the optical power level in the fiber sensing cable.

As is known, the pulse repetition rate is determined by the frequency range to detect the signals, or the number of averages required within a certain period of time. Therefore, for a certain application, the pulse repetition rate in the DFOS is predetermined, and thus the maximum sensing distance is fixed. In summary, each typical DFOS sensor can sense only one fiber route up to the maximum sensing distance. It cannot monitor more than one fiber route at a time, even if these routes are shorter and the combined distance does not exceed the maximum sensing distance.

As will be appreciated, one way to enable more sensing routes is to construct multiple sets of sensor hardware inside a large interrogator. Unfortunately, such an arrangement does not provide much cost saving, as compared to providing multiple interrogators.

We note that it is possible however, to share certain transmitter side hardware (such as the optical source, modulator, transmitter amplifier) among multiple routes, however each route still requires separate receiver side hardware (such as the optical circulator or demultiplexer, receiving amplifier, photodetector, electronic processor). As a result, the cost of providing such multiple route coverage with contemporary approaches is still much higher than a single port interrogator.

Still another way to provide such functionality is to provide an optical switch at the output of the DFOS interrogator and perform round-robin sensing among multiple ports. In such an arrangement, if there are N sensing fiber ports to be monitored, the switch is set to one port for each pulse period (if N=4, the switch will be switch to 1=>2=>3=>4=>1=>2=>3=>4=> . . . ). A drawback of this is that the effective pulse frequency for each port is only 1/N of the original frequency, therefore the signal frequency range will be reduced, or the number of averages within a fixed period will be reduced.

Furthermore, such round-robin sensing operation cannot be easily achieved in practice. This is because a conventional optical switch typically exhibits tens to hundreds of milliseconds switching time(s), during which sensing cannot be performed. Unfortunately, such time is beyond the typical pulse period for sensing operation(s). Consequently, a relatively long time gap is required between sensing different ports which makes round-robin operation infeasible. Accordingly, switching between ports must be done much less frequently than one original pulse period, leading to much longer “blank period” for each port, which of course is unacceptable for many applications since the events might be missed.

The noted infirmities of the art are overcome according to aspects of the present disclosure wherein DFOS systems, methods, and structures employing shared resources use a new scheme that allow flexible resource sharing between sensing distance requirements and route requirements. As such, a DFOS fiber optic sensor cable may be shared among multiple routes with different sensing distance requirements, as long as the combined distance is within the maximum sensing distance allowed. Advantageously, the effective pulse repetition rate for each sensing point is not affected, and no additional sets of transmitter-side hardware or receiver-side hardware is required. As such, resource utilization in a DFOS network according to the present disclosure is advantageously improved for an entire sensing network.

As we shall show and describe, to achieve these new characteristics of DFOS, an ultra-fast optical switch having a synchronous control circuit is employed, together with a non-uniform pulse generation, switching, and data collection scheme through an internal control.

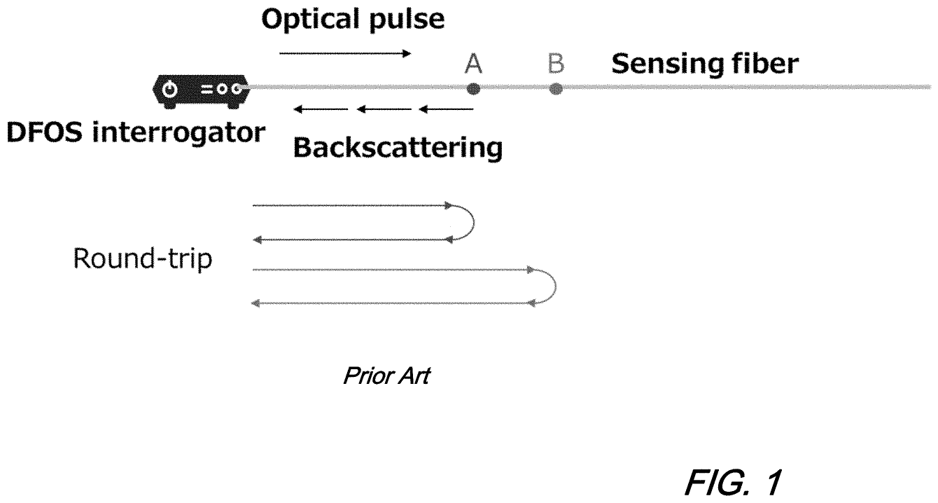

FIG. 1 is a schematic diagram of illustrative backscattered distributed fiber optic sensing operations generally known in the art.

As is known in the art, distributed fiber optic sensing (DFOS) technology is typically based on optical backscattering that occurs inside an optical sensing fiber. As shown schematically in the figure, sensor hardware (a DFOS interrogator) has an optical output port which optically connects to a length of optical sensing fiber that serves as the sensing medium. When the interrogator directs an optical pulse down the fiber length, various types of optical backscattering occur, including Rayleigh backscattering, Brillouin backscattering, and Raman backscattering. These backscattering phenomena are produced due to different physical principles and are associated with different physical stimuli such as temperature, vibration, strain, etc. The backscattering generated at each point travels in a reverse direction of the interrogation optical pulse back to the interrogator, where it is then received by photosensors/photodetector(s) and subsequently converted into electrical signals. The electrical signals are then processed to obtain information about the physical phenomena.

Due to a path length difference, a round-trip time for an optical pulse from pulse transmission to a backscattering signal arriving the photodetector is different for different points on the sensing fiber, such as Point A and Point B shown in the figure. More particularly, a backscattering signal from Point A has shorter round-trip path length than that from Point B, therefore arrives the photodetector earlier. Therefore, the backscattering signals from different points on the fiber have different arrival time at the receiver, spreading along the time axis.

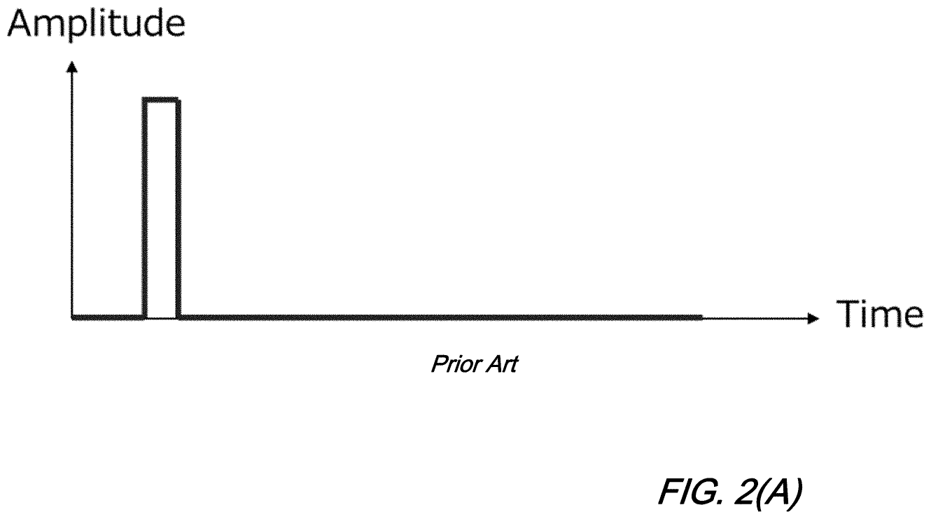

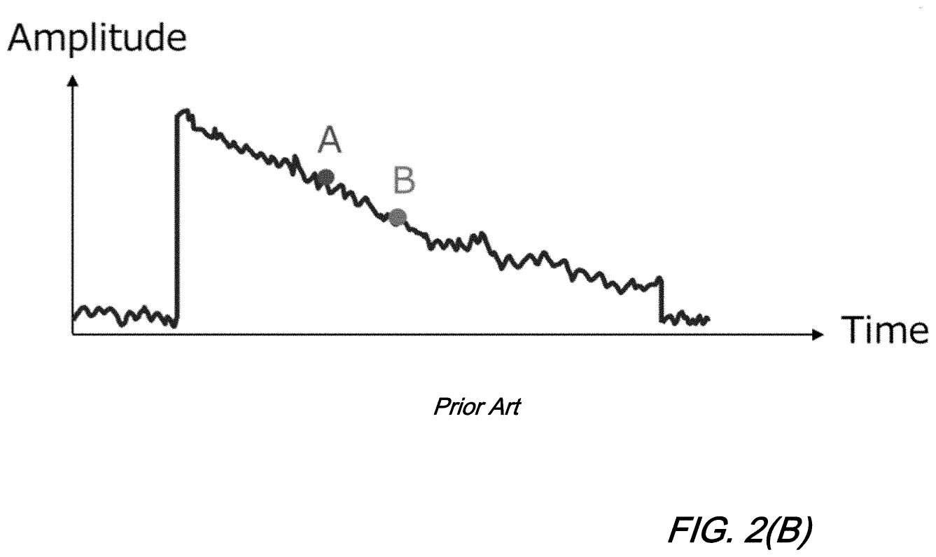

FIG. 2(A) and FIG. 2(B) are plots illustrating transmitted and received optical signals in DFOS in which: FIG. 2(A) shows an optical pulse sent by an interrogator; and FIG. 2(B) shows optical backscattered signals received by the interrogator in response to the sent pulses. As is known and understood by those skilled in the art, by analyzing the round-trip time, the backscattering signals from different points can be differentiated. And therefore, one single DFOS system can detect events/signals at a large number of locations along the entire length of sensing fiber simultaneously.

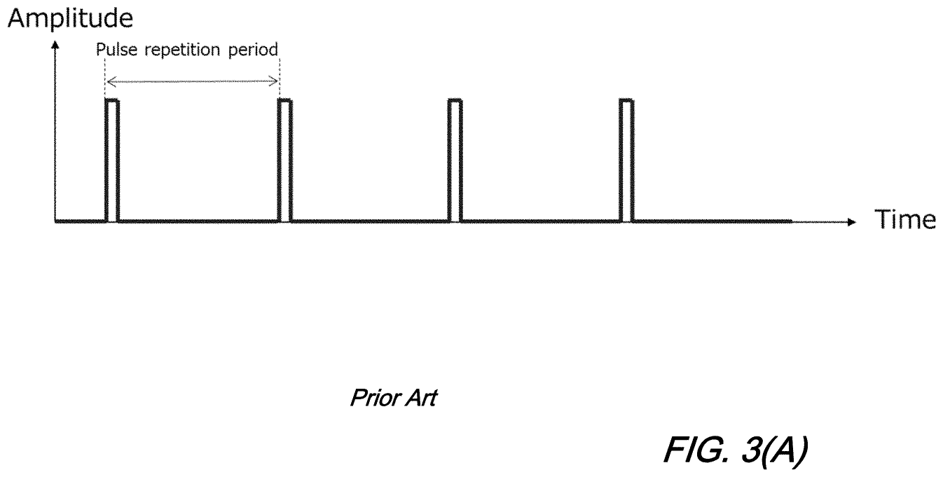

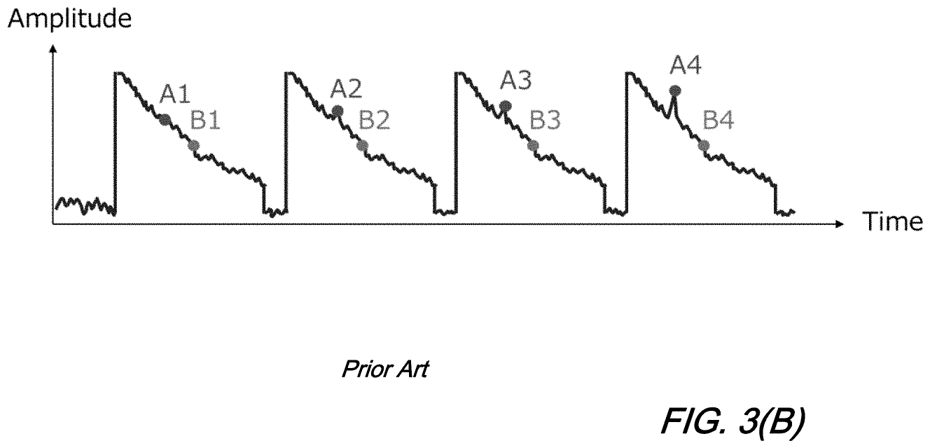

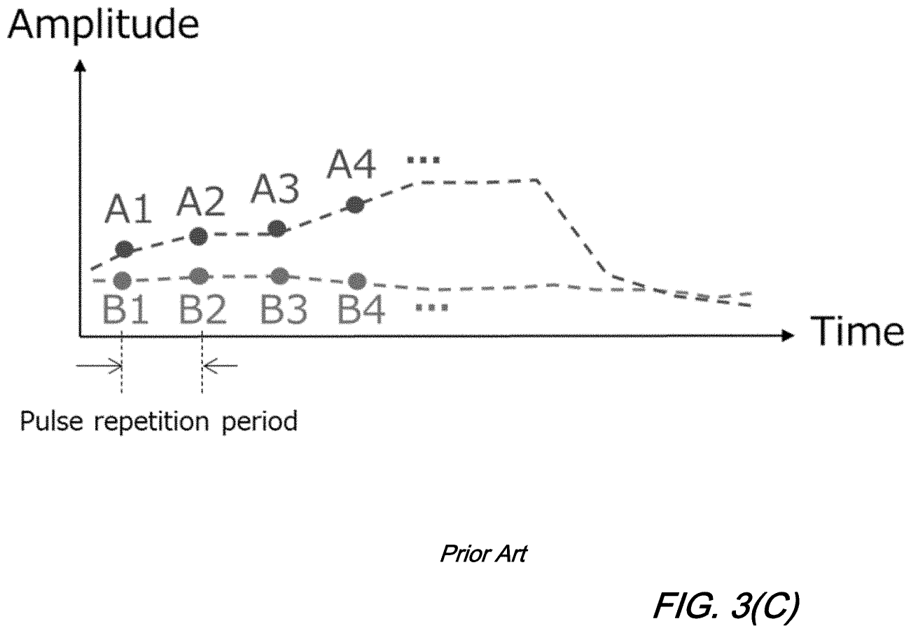

FIG. 3(A), FIG. 3(B), and FIG. 3(C) are plots illustrating optical signals in DFOS continuous operation in which: FIG. 3(A) shows an optical pulse sent by an interrogator; FIG. 3(B) shows optical backscattered signals received by the interrogator in response to the sent pulses; and FIG. 3(C) shows backscattering signal trend for different locations along the optical sensing fiber.

With simultaneous reference to these figures, during a DFOS sensing operation, optical pulses are sent periodically (FIG. 3(A)). The shortest period (i.e. highest repetition frequency) is determined by how long the backscattering signal from the furthest end of the fiber arrives the interrogator detector, which is in turn determined by the length of the sensing fiber and the transmission speed of light inside the fiber. If a subsequent pulse is sent too soon, the backscattering signals from the new pulse and the old pulse will overlap and interfere with each other at detection (here optical pulse coding is not considered)—and will cause a detection error. Even if a user is only interested in the beginning section of the fiber, the entire fiber length needs to be considered.

For each pulse, a backscattering signal for each location on the fiber is received. Therefore, multiple consecutive pulses will produce a series of backscattering signals for each location, such as A1, A2, A3, A4 . . . for location A, and B1, B2, B3, B4 . . . for location B, etc. as shown in FIG. 3(B).

These signals for each location point can be extracted and plotted together to obtain a curve of signal variation for the respective location, such as shown in FIG. 3(C). The time between two adjacent data points is known as the pulse repetition period, and this time resolution affects the sensing performance.

For example, in acoustic or vibration measurements, this temporal resolution determines the maximum signal frequency that can be detected, following Nyquist-Shannon sampling theorem. In another example, temperature measurement usually requires large number of averages to reduce data noise due to low signal level, and the temporal resolution determines the number of averages that can be performed within a fixed amount of time.

Operationally, after a sensing data set (i.e., a curve) for each location is obtained, further data processing operations (such as averaging, filtering, accumulating, smoothing, denoising, etc.) can be performed to obtain further information.

In practical, contemporary applications, the target performance (e.g. frequency range of the signal to be detected, or noise level requirement) is pre-defined by application requirements, therefore the pulse repetition period/frequency is also pre-determined. Since the transmission speed of light pulses in the fiber is constant, the maximum allowed fiber length is fixed.

Therefore, current, prior art DFOS systems can only support one route (one fiber optic sensing cable) with fixed maximum distance. As will be understood and appreciated by those skilled in the art, such a limitation is not only inflexible, but leads to the waste of resource.

In a typical example, if a fiber optic sensor cable is designed/configured to detect a vibration signal from a stationary (DC) source up to 2.5 kHz, the minimum pulse repetition period is about 200,000 ns (corresponding to a pulse repetition frequency of 5 kHz), and therefore can support only one regular, fiber optic sensing cable route of about 20 km distance. If the actual cable route is only 5 km, the remaining 75% extra resource cannot be utilized on other routes.

As noted previously, providing multiple sets of sensor hardware is not cost effective since such hardware cost will increase, even if some hardware components (such as the transmitter optics, controller, power supply, enclosure, etc.) are shared.

One alternative approach is to add a 1×N optical switch at the output of DFOS to share the interrogator among N routes. However, the typical switching time for an optical switch is tens of milliseconds for MEMS and prism switches, and hundreds of milliseconds for stepper motor-based optical switches.

For a typical switching time of 30 milliseconds, the switching time is 150 times longer than the original pulse period in the example shown above. In other words, the interrogator needs to stop its sensing operation for 150 periods during one switching operation. Therefore, it is not possible to perform multi-route sensing operation in a per-period round-robin fashion. Such switch is usually used to select one route out of the N routes for sensing, instead of sensing all N routes sequentially.

Even if per-period round-robin sensing is achieved, the effective pulse repetition frequency will also be reduced by N times.

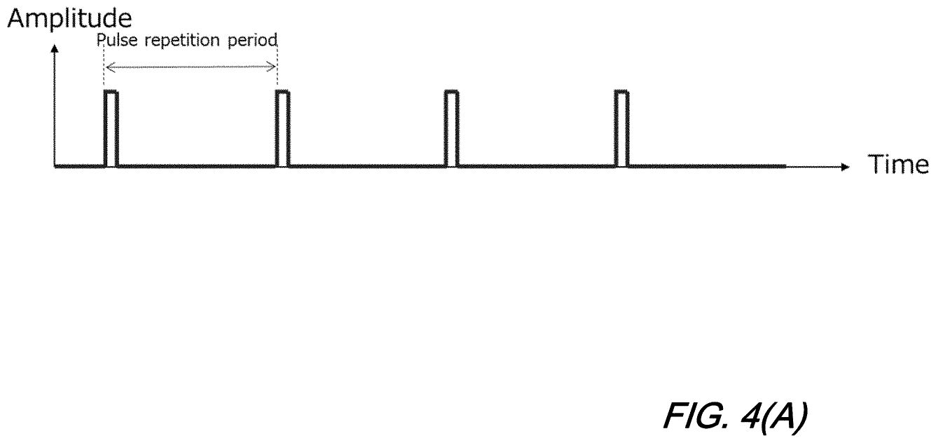

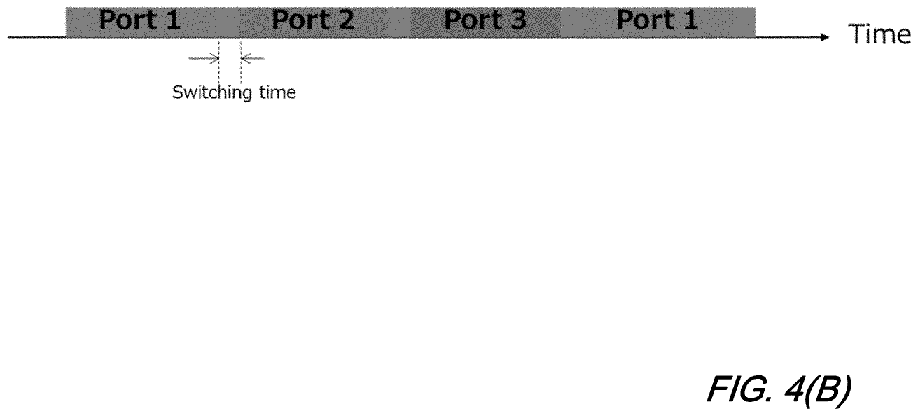

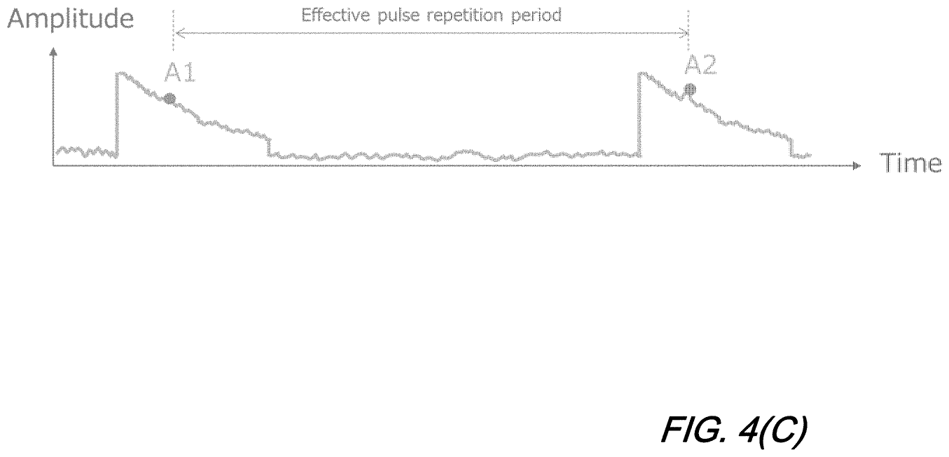

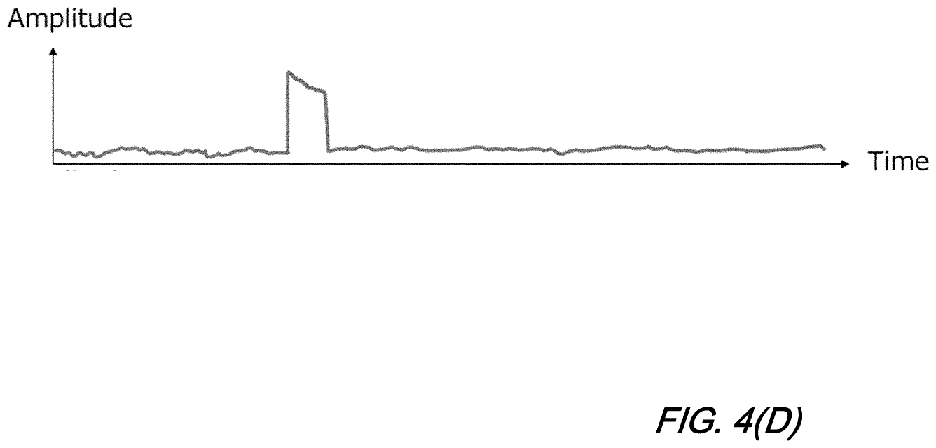

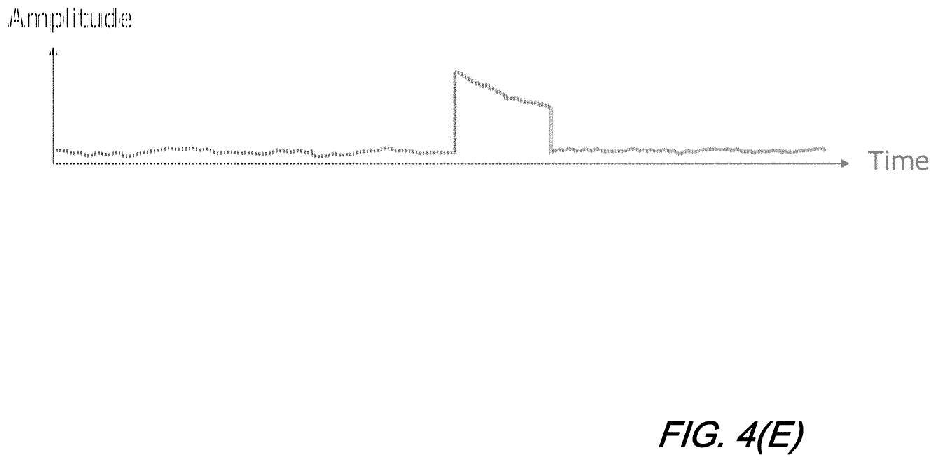

FIG. 4(A), FIG. 4(B), FIG. 4(C), FIG. 4(D), and FIG. 4(E) are plots illustrating round-robin operation among 3 sensing routes in which: FIG. 4(A) shows an optical pulse sequence sent by an interrogator; FIG. 4(B) shows optical switch output port(s) that individually correspond to individual pulses of FIG. 4(A); FIG. 4(C) optical backscattered signals from a Route 1 received by the interrogator in response to the sent pulses; FIG. 4(D) shows optical backscattered signals from a Route 2 received by the interrogator in response to the sent pulses; and FIG. 4(E) shows optical backscattered signals from a Route 3 received by the interrogator, according to aspects of the present disclosure.

With simultaneous reference to these figures, if the interrogator is shared among 3 routes, each route only receives 1 pulse for every 3 pulses sent. Therefore, the effective pulse frequency is only 1/3 of the original frequency (3 times the original period). Consequently, the measurable signal frequency range is also reduced to 1/3, or the number of averages within a fixed period is reduced to 1/3.

To overcome such infirmities, an ultra-fast optical switch is added at the output of the single channel DFOS interrogator. Such optical switches exhibit a nanosecond level switching time. Some examples of useful switches include solid state optical switches, such as those based on electro-optic effect or magneto-optic effect. Other electro-optic modulators used in high-speed optical transmitters can also achieve a sufficient ultra-fast switching. Compared with the 200,000 ns pulse period in the example above, the <10 ns switching time is only 0.005% overhead in the time domain, which can almost be ignored. Because such solid-state switches do not have mechanically moving parts, they have long lifetime and can be operated continuously over decades.

Together with the ultra-fast 1×N optical switch, a synchronous control circuit is added. The circuit ensures that the timing of pulse generation and the timing of optical switching are synchronized and are also synchronized with the data processing at the receiver output. Unlike the single channel sensing operation and the round-robin sensing operation in which the optical pulses are generated and transmitted with a fixed period (i.e. same frequency), the optical pulses are transmitted at different timing based on the current route and distance plan.

Advantageously, and according to further aspects of the present disclosure, the timing can be changed flexibly if the route and distance plan is changed. This can be achieved by a DAC (digital-to-analog converter) with a fine sampling rate (such as one sample every nanosecond or every few nanoseconds). The pulse duration can be the same as the original single channel interrogator.

Under the control of the synchronous control circuit, the ultra-fast optical switch performs the switching operation to select the targeted output channel (fiber port), and after that the optical pulse is generated and transmitted down the fiber, and the receiver starts to collect the backscattering signals, and mark it under the current channel. The control circuit then uses the distance information for this particular route to determine how long is needed for the backscattering signal from the furthest end to be received and wait for it to complete. Then it controls the switch to select the next port, if the current system is measuring more than one port, then send the pulse, mark the received data under the new channel, and so on.

With such an ultra-fast 1×N switch, the DFOS interrogator is connected to N output fiber optic routes. Depending on the sensing needs, partial or all N fiber routes can be measured simultaneously, so long as the combined length of the measured fiber is less than the maximum sensing distance of the interrogator in single route operation.

If we consider a configuration wherein the maximum sensing distance for single route operation is 20 km, with the 0 to 2.5 kHz vibration sensing range and a configuration having 6 or more routes. Our fiber optic sensor arrangement according to aspects of the present disclosure can have—for example—a 1×6 ultra-fast optical switch connecting to a Route A with 10 km fiber, a Route B with 20 km, a Route C with 5 km, a Route D with 8 km, a Route E with 5 km, and a Route F with 2 km. Depending on the sensing needs, the fiber optic sensor cable can detect one single route entirely (Route B), or a combination of multiple routes, such as Routes A+C+E, or Routes A+C+F, or Routes A+D, or Routes C+D+E+F, or Routes C+E+F, etc. Because there is no change to the original pulse repetition period, all the routes in each of these configurations can be sensed with the same vibration frequency range (or the same number of averages within the same period of time). Therefore, flexible sensor resource sharing is achieved between the route configuration and distance configuration, delivering high resource utilization efficiency, while maintaining the same performance as the original single route sensor.

FIG. 5 is a schematic diagram showing illustrative examples of different sensing configurations enabled by resource sharing DFOS system according to aspects of the present disclosure.

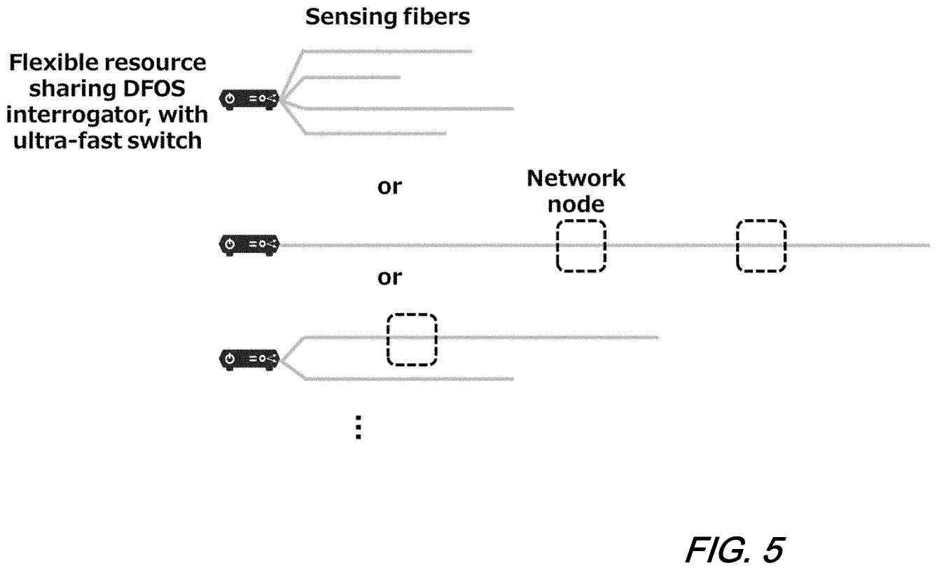

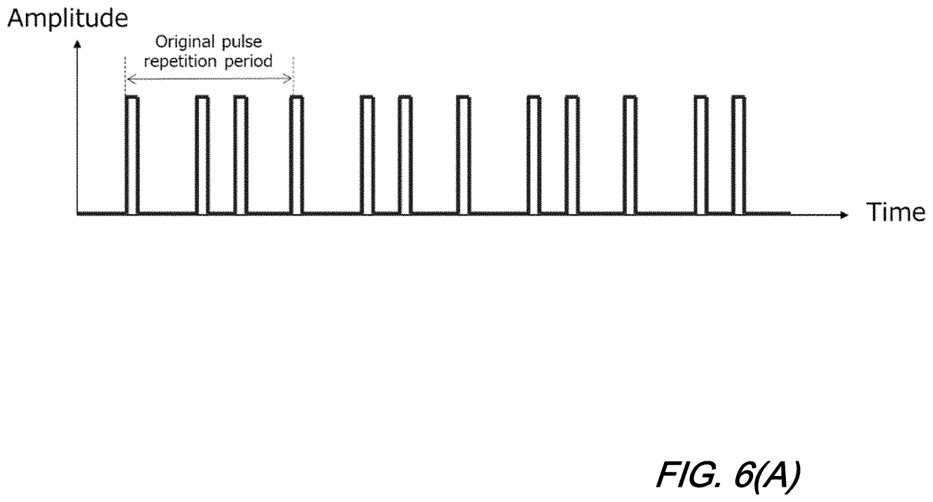

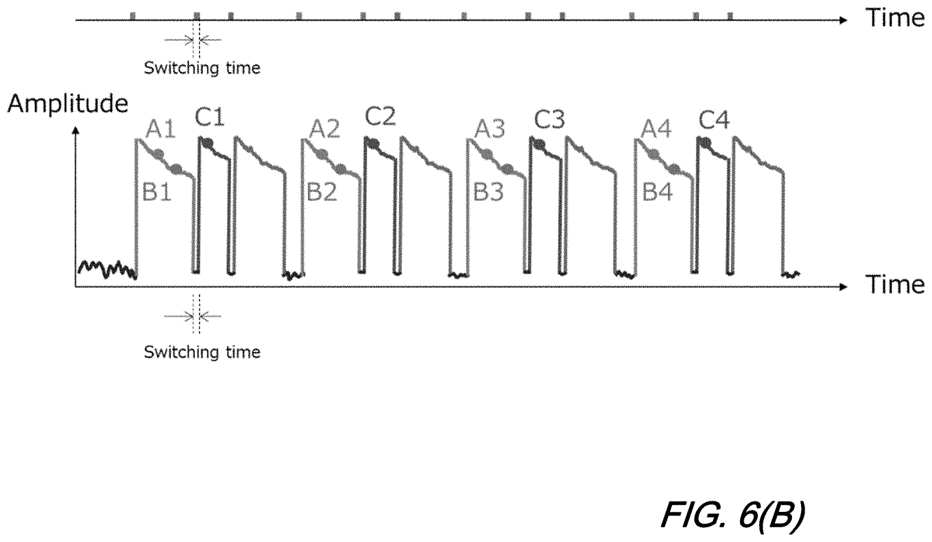

FIG. 6(A) and FIG. 6(B) are plots illustrating transmitted and received optical signals in a resource sharing DFOS according to the present disclosure in which: FIG. 6(A) shows an optical pulse sequence sent by an interrogator; and FIG. 6(B) shows corresponding ultra-fast optical switch output port and optical backscattered signals received by the interrogator in response to the sent pulses according to aspects of the present disclosure. With reference to these figures, we note that operation, the controller (could be a centralized controller for a sensor network, or a local controller for an individual interrogator) analyzes the sensing needs and selects the routes to be measured. It then uses the route and distance information to determine timing for the pulse generation, as well as the timing of the optical switching. The interrogator uses the calculated information to generate pulses and switch the ultra-fast optical switch through the control circuit, as described earlier, as well as to distribute the received signal among different routes.

In the illustrative example shown, three routes are being sensed at the same time. Within one original pulse repetition period (say, 200,000 ns), three pulses are transmitted with uneven timing, because the sensing fiber distances in these three routes are different. When the sensing operation for the first route is finished (i.e. the backscattering signal from the far end is received at the receiver), the ultra-fast switch is controlled to switch to the second route. After the switching operation is completed (which is very short, only a few nanoseconds), another pulse is sent, which travels down the second route and generates a backscattering signal from the second route. Subsequently the sensing is performed on the third route. The sensing of the third route is completed before the original pulse repetition period, and the optical switch is switched back to the first route.

In the next period, the sensing/switching operations are repeated. As such, the effective pulse repetition period for each location on each fiber remains the same as the original pulse repetition period. A same data extraction and combination can be done to obtain the raw sensor data curve for each location for further processing or display, such as A1˜A4, B1˜B4, C1˜C4 in the figure. Based on the sensing route arrangement, the sensor controller sorts each curve under its corresponding route. For example, A1˜A4 curve and B1˜B4 curve are for the first route, and C1˜C4 curve is for the second route. Consequently, they will be processed under their own route's sensing requirement.

Note that these curves have the same temporal resolution as the original single port sensor, therefore the detectable signal frequency range and the achievable number of averages per unit time remain the same in all these different configurations and combinations. Of course, if the user wants to change the pulse repetition period, it can also be achieved, so long as the new combined route length is within the new maximum allowed sensing distance.

At this point, we again note that in recent years, the utilization of distributed fiber optic sensing has been expanded from individual single location applications to network-level operations. The growing number of fiber optic communication networks are beginning to be used as a DFOS sensing media, providing more functions and delivering more value from the network infrastructure. Accordingly, concepts such as Infrastructure-as a-Sensor (IaaSr) and Network-as-a-Sensor (NaaSr) are emerging rapidly. Sensing fiber routes are evolving from simple straight lines to networks with larger scales and more complex topologies. As such, configuration flexibility and scaling capability are becoming increasingly more important.

Our DFOS system with distance-route resource sharing capability meets the requirements and can deliver outstanding value as applied to the IaaSr and NaaSr applications. Instead of supporting only one single sensing fiber route, DFOS systems, methods and structures according to the present disclosure can advantageously be flexibly and dynamically configured to support multiple routes in a tree—or other—network topologies. If multiple sets of such DFOS systems are deployed in a network, a full meshed network sensing coverage can be achieved.

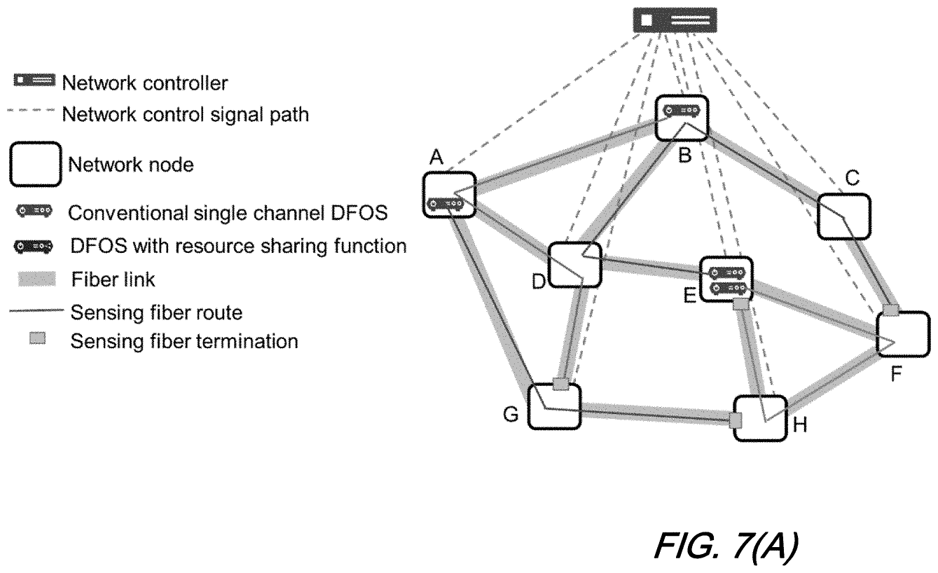

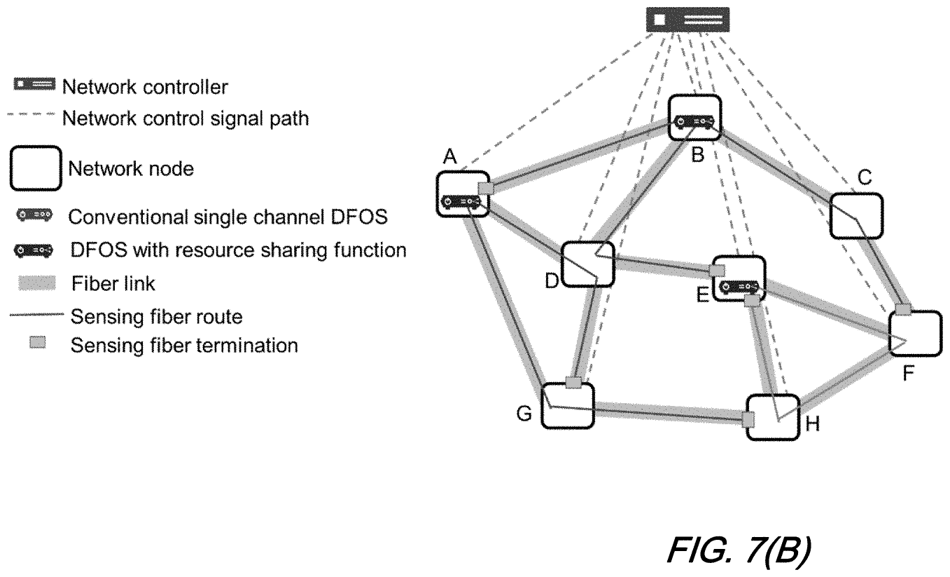

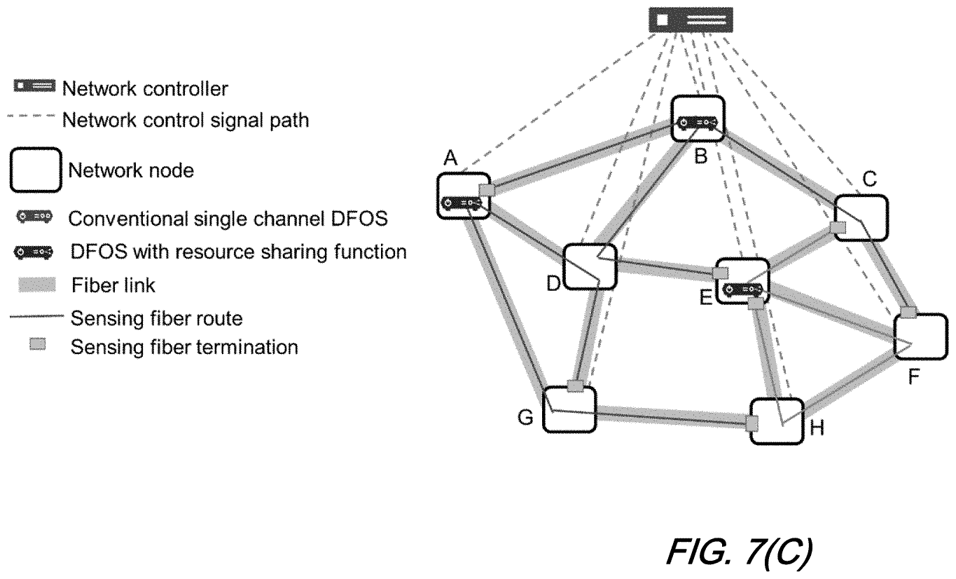

FIG. 7(A), FIG. 7(B), and FIG. 7(C) are schematic diagrams illustrating examples of hardware saving and new service provisioning by a resource sharing DFOS system according to aspects of the present disclosure.

With simultaneous reference to those figures, we note that since one sensor can be used to detect multiple routes simultaneously, the amount of DFOS sensor hardware can be reduced to substantially save the capital expense related to sensor deployment.

In the example illustrated in FIG. 7(A), each of the conventional DFOS sensors can only support one port, therefore four sensors are needed. In contrast, according to aspects of the present disclosure employing our innovative resource-sharing DFOS, only three sensors are needed, as shown illustratively in FIG. 7(B). Since the sensor in Node A can serve both AGH route and ADG route simultaneously, and the sensor in Node B can support BA route, BDE route, and BCF route simultaneously, one sensor is eliminated (assuming that the combined sensing link distance is still within the maximum sensing distance).

Note that since the sensing route configuration in each DFOS sensor can be changed dynamically without any hardware modification, the sensing network arrangement can be modified easily as the sensing need changes, such as adding a new sensing link or changing one. For example, if a new sensing link of EC is added, since the sensor in Node E still has extra remaining resource (maximum sensing distance not reached), it can be used to serve the new route by switching between an original EDHE route and a new EC route, as shown illustratively in FIG. 7(C).

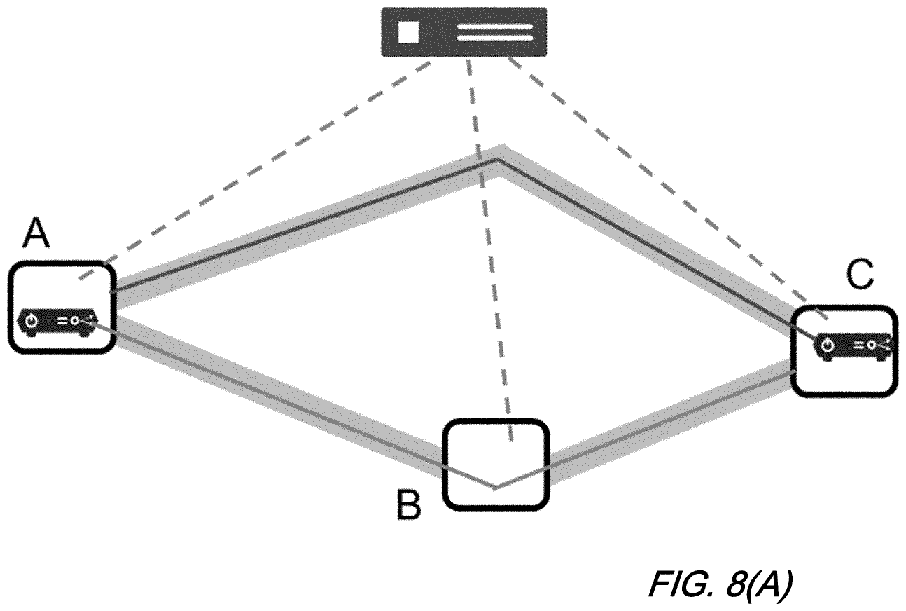

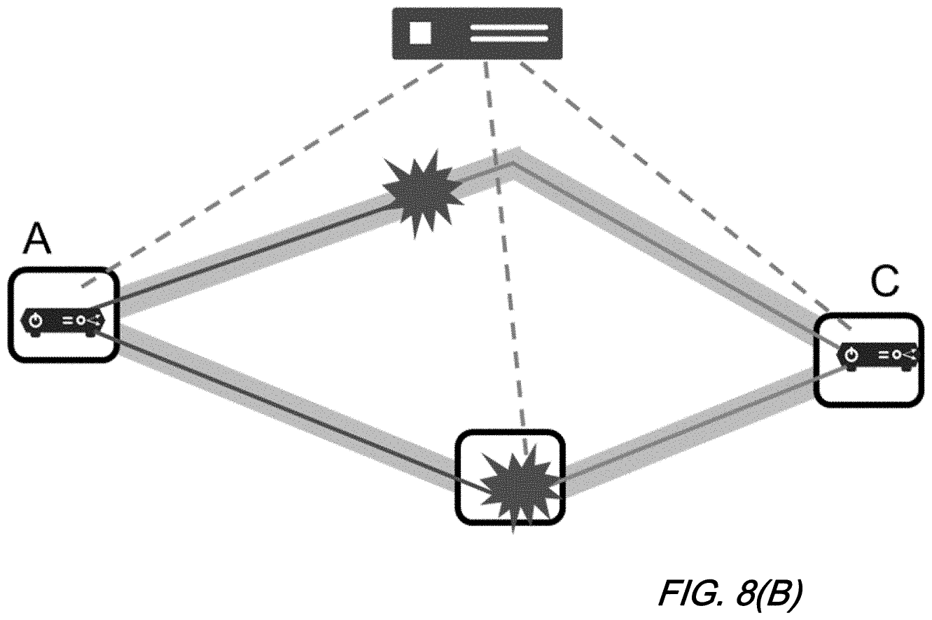

In addition, exhibiting a capability to share the resource between multiple routes is also very useful for providing network protection. FIG. 8(A), and FIG. 8(B) are schematic diagrams illustrating examples of protection by a resource sharing DFOS according to aspects of the present disclosure.

With reference to those figures, we note that in FIG. 8(A), the 2 sensors in Nodes A and C serve two routes between these 2 nodes respectively during normal operation. But if there is a failure in a route, such as a fiber cable cut in the upper route, and/or the Node B hardware failure in the lower route, the two sensors can be reconfigured via the network controller to sense two “broken routes” each, such as shown illustratively in FIG. 8(B). As a result, the sensing function for both routes can still be achieved without requiring additional sensor(s). Such functionality cannot be achieved with conventional, prior-art, single port DFOS sensors. In that prior-art scenario, two additional sensors will be required to provide the protection function, and thus four sensors in total (two in Node A and two in Node B) are needed.

As noted previously, our inventive DFOS system, method and structure according to aspects of the present disclosure can deliver a flexible resource sharing between the distance and the route arrangements in a fiber optic sensing network, which in turn leads to numerous advantages in network sensing applications, including hardware cost saving(s), rapid provisioning or re-provisioning of sensing services, and efficient and cost-effective protection. Advantageously, our inventive systems and methods do not sacrifice sensing performance. Instead, it maintains a same sensing frequency range and same average amount within a unit time. Of further advantage, resource sharing can be done easily through software control remotely at any time, without physically modifying on-site hardware. As a result, our inventive resource sharing DFOS systems, methods, and structures provide a practical solution for a new generation fiber optic sensing application.

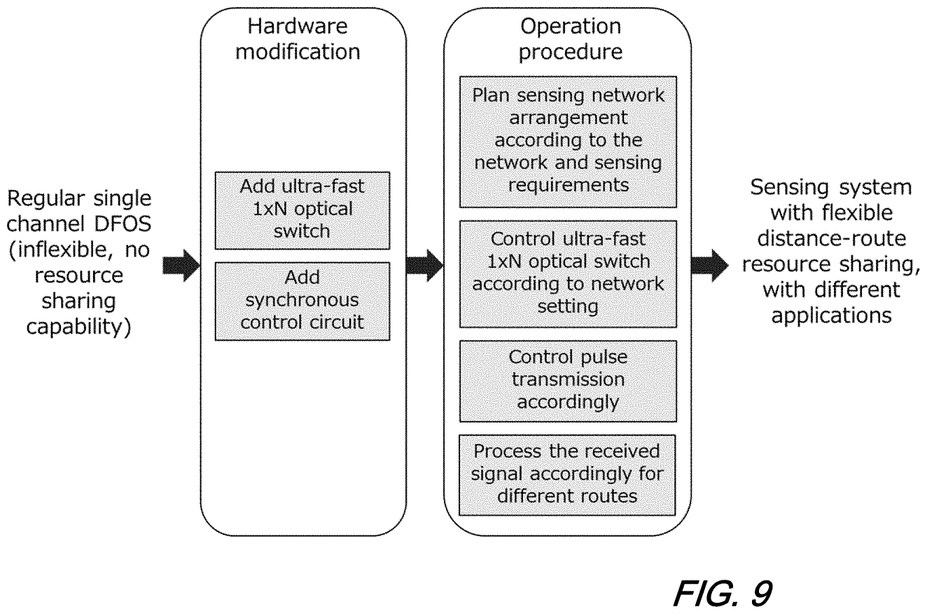

FIG. 9 is a flow diagram showing a hardware modifications and operation procedures for shared-resource DFOS according to aspects of the present disclosure. As may be observed from that figure, a regular, prior-art single channel DFOS is both inflexible and does not generally provide any resource sharing. To overcome such infirmities, our inventive systems and methods employ an ultra-fast 1×N optical switch interposed between an interrogator and fiber optic sensor and a synchronous control circuit which provides for the real time control and operation of our shared system. Operationally, systems, methods, and structures according to aspects of the present disclosure involve the planning of a sensing network arrangement according to network and sensing requirements. Controlling the ultra-fast 1×N optical switch according to network/sensing requirements; controlling the pulse transmission(s) accordingly and processing the received backscatter signal(s) for different routes.

At this point, while we have presented this disclosure using some specific examples, those skilled in the art will recognize that our teachings are not so limited. In particular, we have successfully demonstrated abnormal activity detection and threat assessment for fiber optic cable protection with respect to live network, operational telecommunications fiber optic networks. By leveraging fiber optic sensing and machine learning technologies, abnormal events can be discovered and pinpointed at any point along fiber optic cable routes. Additionally, our protection system provides an evaluation of a threat level based on a distance from event(s) to the fiber optic cable and simultaneously defines a protection zone around the fiber optic cable based on the frequency-dependent attenuation mechanism. Once an event within the protection zone is discovered, a critical warning alert can be sent out to operators or systems immediately. The field trial results show that the proposed system can help telecommunications service providers to identify threat constructions near fiber optic cables in real time and prevent fiber optic cable damage. Accordingly, this disclosure should only be limited by the scope of the claims attached hereto.

1. A distributed fiber optic sensing (DFOS) system exhibiting distance-route resource sharing, said system comprising
N individual fiber optic sensing cables, each one defining an individual fiber optic sensing route;
a 1×N optical switch, the optical switch having 1 input port and N output ports, each individual one of the N output ports in optical communication with a respective one of the N individual fiber optic sensing cables,
a single channel, DFOS optical interrogator in optical communication with the input port of the optical switch, the optical interrogator configured to generate interrogator optical pulses, introduce them into the input port of the optical switch, and receive backscattered signals from the optical switch, and
a synchronous control circuit for controlling the timing of pulse generation and timing of optical switching such that they are synchronized;
wherein the optical switch is configured by the synchronous control circuit to receive the interrogator optical pulses and direct them to an appropriate one of the N individual fiber optic sensing cables, and receive backscattered signals from that individual one of the N fiber optic sensing cables and direct them to the interrogator for analysis;
wherein the optical switch exhibits an ultra-fast switching time of <10 ns, and the optical pulses generated by the single channel DFOS optical interrogator are generated and transmitted at timing based on a current fiber optic sensing route and distance of that current fiber optic sensing route.

2. The system of claim 1 wherein all N fiber optic sensing routes are measured simultaneously when a combined length of the measured routes is less than a maximum sensing distance of the interrogator operating in a single route configuration.

3. The system of claim 2 wherein one or more of the N fiber optic sensing routes include at least a portion another one of the N fiber optic sensing routes.

4. The system of claim 3 wherein the one or more of the N fiber optic sensing routes that include at least a portion of another one of the N fiber optic sensing routes are reconfigured by the synchronous controller during a failure or other predetermined network event.
